(19) United States
(12) Patent Application Publication
(10) Pub. No.: US 2025/0176504 A1
(43) Pub. Date: Jun. 5, 2025

(54) VARIABLE-VOLUME CONE FOR RESTRAINING BIRDS

(71) Applicant: ARDISAM, INC., Cumberland, WI (US)

(72) Inventor: Scott Andrew WALDAL, Hudson, WI (US)

(21) Appl. No.: 18/529,891

(22) Filed: Dec. 5, 2023

(51) Int. Cl. A01K 37/00; A01K 45/00

(52) U.S. Cl. CPC A01K 37/00; A01K 45/005

(57) ABSTRACT

A restraint device for harvesting birds may include a flexible sheet configurable between a first configuration in which the flexible sheet is flat, a second configuration in which the flexible sheet is formed into a conical shape having a first interior volume, an upper opening, and a lower opening smaller than the upper opening, and a third configuration in which the flexible sheet is formed into a conical shape having a second interior volume that is different from the first interior volume. The restraint device may include two or more elongated openings positioned to receive corresponding hook elements to secure the flexible sheet in the second or third configuration.

### BACKGROUND

Raising and harvesting birds (e.g., poultry) for consumption can involve several steps. Some of the final steps may include dispatching the bird, scalding the bird, defeathering the bird, eviscerating the bird, or packing the meat for storage. Many at-home or backyard poultry processors use a restraining cone while dispatching a bird to support the bird upside down with the head and neck exposed. This makes the blood pool in the bird's head, which makes them drowsy for humane dispatching.

Conventional restraint cones, which are typically made of sheet metal joined to itself by a folded metal joint or a weld, are not adjustable and must be purchased to correspond with the size of the bird, which can vary depending on the breed or age of the bird. As a result, backyard poultry processors may need multiple cones of various sizes, which increases costs and storage volume. Conventional cones are also shipped in a finished or assembled form, which results in the shipment packages being oversized, costly, and inefficient due to the empty volume inside. Conventional rigid cones may also fail to restrain a bird completely because the bird's body profile may not match the contour of a rigid cone, so a bird may be able to escape a rigid cone. Conventional cones also have a fixed seam that can collect blood or other debris and can be difficult to clean, resulting in unsanitary conditions.

Aspects of embodiments of the present technology address these issues and other issues.

### SUMMARY

Representative embodiments of the present technology include a restraint device for harvesting birds. In some embodiments, the restraint device may include a flexible sheet configurable between a first configuration in which the flexible sheet is flat, a second configuration in which the flexible sheet is formed into a conical shape having a first interior volume, an upper opening, and a lower opening smaller than the upper opening, and a third configuration in which the flexible sheet is formed into a conical shape having a second interior volume that is different from the first interior volume. The restraint device may include two or more elongated openings positioned to receive corresponding hook elements to secure the flexible sheet in the second or third configuration.

Other features and advantages will appear hereinafter. The features described above can be used separately or together, or in various combinations of one or more of them.

### BRIEF DESCRIPTION OF THE DRAWINGS

In the drawings, wherein the same reference number indicates the same element throughout the several views:

FIG. 1 illustrates a rear perspective view of a variable-volume restraint cone in an assembled configuration, according to embodiments of the present technology;

FIG. 2 illustrates a perspective view of the variable-volume restraint cone shown in FIG. 1, in a disassembled configuration, according to embodiments of the present technology;

FIG. 3 illustrates a rear perspective view of the variable-volume restraint cone shown in FIG. 1, in another assembled configuration for receiving a smaller-sized bird than the configuration shown in FIG. 1, according to embodiments of the present technology;

FIG. 4 illustrates a rear perspective view of the variable-volume restraint cone shown in FIG. 1, in yet another assembled configuration in which the seam is bulged to change the interior contour or volume of the cone, according to embodiments of the present technology; and

FIG. 5 illustrates a perspective view of the variable-volume restraint cone in an assembled configuration, according to embodiments of the present technology.

### DETAILED DESCRIPTION

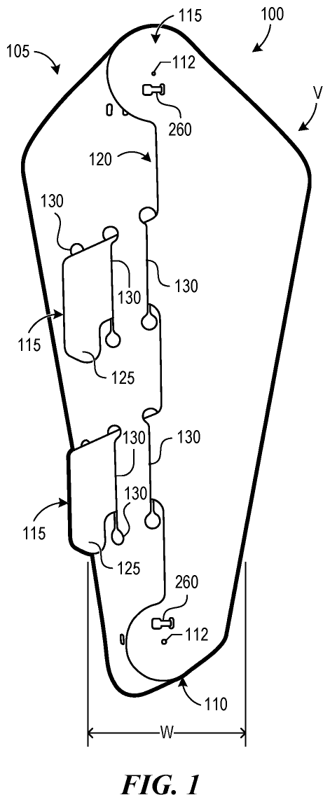

The present technology is directed to variable-volume restraint cones for birds, and associated systems and methods. Various embodiments of the technology will now be described. The following description provides specific details for a thorough understanding and enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments. Accordingly, embodiments of the present technology may include additional elements or exclude some of the elements described below with reference to FIGS. 1-5, which illustrate examples of the technology.

The terminology used in this description is intended to be interpreted in its broadest reasonable manner, even though it is being used in conjunction with a detailed description of certain specific embodiments of the technology. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all the items in the list, or (c) any combination of items in the list. Numerical adjectives including “first” and “second,” or the like, as used in the present disclosure, do not convey hierarchy or specific features or functions. Rather, such numerical adjectives are intended to aid the reader in distinguishing between elements which may have similar nomenclature, but which may differ in position, orientation, or structure. Accordingly, such numerical adjectives may be used differently in the claims. As used herein, the terms “generally” and “approximately” refer to values or characteristics within a range of ±10% from the stated value or characteristic, unless otherwise indicated.

FIG. 1 illustrates a rear perspective view of a restraint device for harvesting birds, in the form of a variable-volume restraint cone 100, according to embodiments of the present technology. The restraint cone 100 is shown in an assembled or use configuration in FIG. 1. The cone 100 provides two or more different sizes or shapes as a result of several features described below.

In general, the cone 100 includes a top opening 105 that is larger than a bottom opening 110. A bird may be received in the top opening 105 such that its head and neck extend from the bottom opening 110. Due to the conical shape of the cone 100, the interior volume V may taper from the top opening 105 to the bottom opening 110. The cone 100 may be attached to a supporting structure (not shown) such as a pole or a wall, via one or more mounting holes 112 and suitable fasteners, such as screws or bolts.

The cone 100 may include adjustment features 115 that enable gross adjustment for bird size and a finer adjustment to adjust the contour of the conical shape to more precisely accommodate a bird's shape or size. For example, a joint or seam 120 where ends of the cone 100 join together may be adjustable to allow a user to customize an interior volume V of the cone 100 or a width W of the cone 100 where a bird's breast may be positioned when in use, as explained in further detail below.

In some embodiments, the adjustment features 115 may include one or more hook elements 125 and one or more corresponding elongated openings 130, such as slits, positionable to receive the one or more hook elements 125. There may be one elongated opening 130 for each hook element 125, two elongated openings 130 for each hook element 125, three elongated openings 130 for each hook element 125, or more elongated openings for each hook element 125. The elongated openings 130 corresponding to a hook element 125 may be parallel to each other and positioned at varying distances from the hook element 125. For example, each hook element 125 may slide into a corresponding first elongated opening 130, and then slide downwardly such that the hook element 125 extends out of, and below, the elongated opening 130 to hold the cone 100 in an assembled configuration. In some embodiments, as shown in FIG. 1, each hook element 125 may slide into a first elongated opening 130, and then out of a second elongated opening 130, and then downwardly to hold the cone 100 in the assembled configuration. Each hook element 125 may be positioned or locked into any of the corresponding elongated openings 130 to provide a coarse adjustment to the interior volume V of the cone 100.

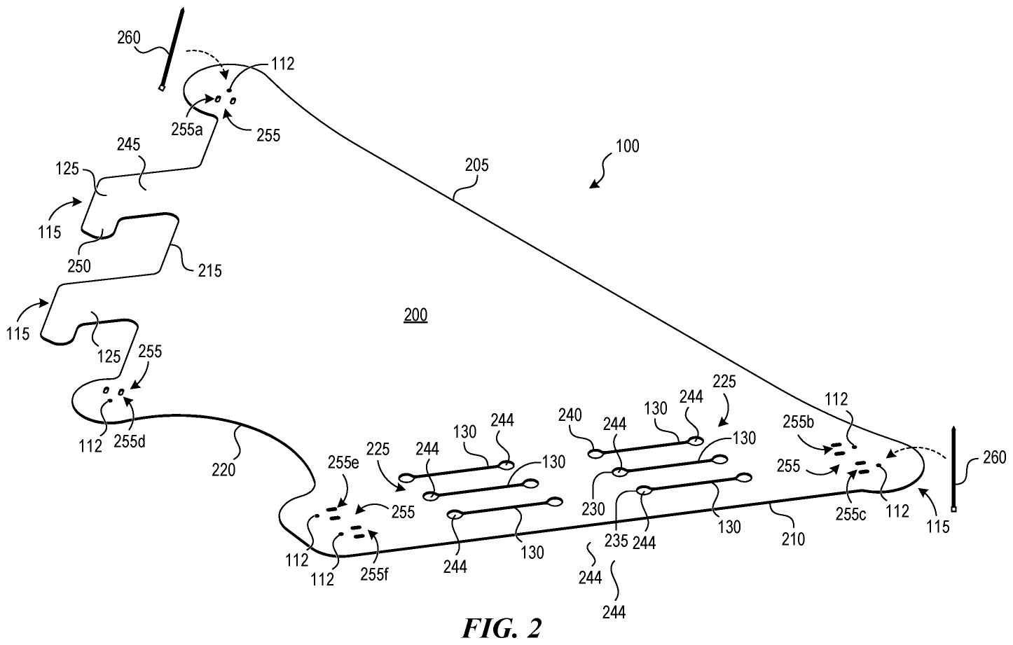

FIG. 2 illustrates a perspective view of the variable-volume restraint cone 100 shown in FIG. 1, in a disassembled configuration, according to embodiments of the present technology. In some embodiments, the disassembled configuration may include a flat or mostly flat configuration (e.g., planar). The disassembled configuration facilitates cleaning by allowing a user access to all surfaces of the cone 100, and it facilitates efficient shipment and storage by allowing stacking or storing in the flat configuration.

In some embodiments, when the cone 100 is in the disassembled configuration, it is in the form of a flexible sheet 200 having a first side 205, a second side 210 adjoining the first side 205 and extending transversely to the first side 205, a third side 215 adjoining the first side 205 and extending transversely to the first side 205, and an arcuate fourth side 220 joining the second side 210 and the third side 215 opposite from the first side 205. In some embodiments, the fourth side 220 may be omitted, such that the second side 210 directly adjoins the third side 215, as long as the assembled configuration (see FIG. 1) still has a bottom opening 110 sized and shaped to allowing a bird's head or neck to protrude out of the cone 100. In some embodiments, the fourth side 220 may have an arcuate shape forming a recess in the sheet 200. The assembled configuration shown in FIG. 1 comprises the flexible sheet 200 curled upon itself to form the conical shape of the cone 100.

In some embodiments, the second side 210 may include the elongated openings 130 adjacent to, and extending along (e.g., parallel to) the second side 210. In some embodiments, a group 225 of elongated openings 130 may include two or more (such as three) elongated openings 130 spaced apart from the second side 210 at different distances from each other, in a row. For example, a first elongated opening 230 may be positioned between a second elongated opening 235 and the second side 210, and the first elongated opening 230 may be positioned between the second elongated opening 235 and a third elongated opening 240 in the group 225.

Each other group 225 of elongated openings 130 may optionally be similar, and a number of groups 225 of elongated openings 130 may correspond to a number of hook elements 125. For example, as shown in FIG. 2, there may be two hook elements 125 and two groups 225 of elongated openings 130. In some embodiments, one or more (such as each) of the elongated openings 130 may include one or more relief openings 244 positioned at the ends of the elongated openings 130. The relief openings 244 may be wider than a remainder of the elongated openings 130 and may have rounded shapes to relieve stresses on the elongated openings 130 when they encounter forces from assembly or operation.

The elongated openings 130 may be positionable to receive a corresponding hook element 125. In some embodiments, the one or more hook elements 125 may extend from the third side 215. At least one (or all) of the hook elements 125 may include a first portion 245 extending from the third side 215, and a second portion 250 extending transversely from the first portion 245 to form a hook shape to engage the elongated openings 130. In some embodiments, the second portion 250 may extend along a direction that is parallel the third side 215.

In some embodiments, the cone 100 may include adjustment openings 255 for providing finer adjustment of the interior volume V or the interior contour of the cone 100. In some embodiments, the adjustment openings 255 may be positioned at each intersection among the first side 205, second side 210, third side 215, and fourth side 220. Each group 255 may include one or more adjustment openings. For example, in some embodiments a first group of adjustment openings 255a near the first side 205 may be mated with a second group of adjustment openings 255b, or with a third group of adjustment openings 255c. The second and third groups 255b, 255c may be located at different distances from the second side 210 or from the first group 255a, which results in a wider or narrower top opening 105, depending on which groups 255 are mated together.

Similarly, a fourth group 255d near the fourth side 220 may be mated with a fifth group of adjustment openings 255e or with a sixth group of adjustment openings 255f. The fifth and sixth groups 255e, 255f may be located at different distances from the second side 210 or from the fourth group 255d, which results in a wider or narrower bottom opening 110, depending on which groups 255 are mated together. In some embodiments, the groups 255 or individual adjustment openings within the groups 255 may be mated together using any suitable device, such as zip ties 260, or other devices such as snaps or clips. The adjustment openings 255 and the fastening devices, such as the zip ties 260, form a secondary or fine adjustment to selectively increase or decrease the volume V of the cone 100 or to selectively adjust the interior contour of the cone 100. Other embodiments may include other devices or mechanisms to selectively increase or decrease the sizes of the top opening 105 or the bottom opening 110. Other embodiments may further include more or fewer groups of adjustment openings 255 for facilitating additional size adjustability.

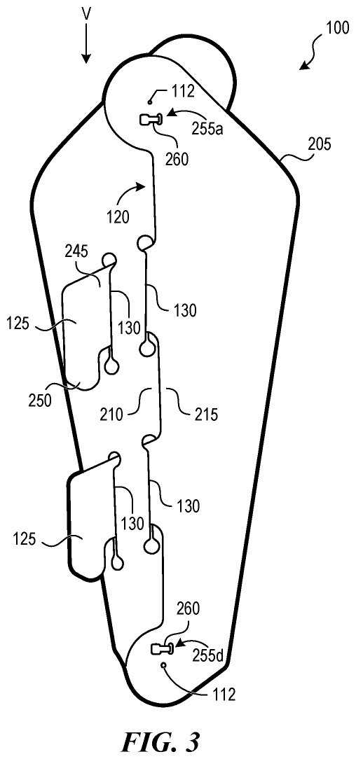

FIG. 3 illustrates a rear perspective view of the variable-volume restraint cone 100 shown in FIG. 1, in another assembled configuration for receiving a smaller-sized bird than the configuration shown in FIG. 1, according to embodiments of the present technology. In FIG. 3, the hook elements 125 engage elongated openings 130 that are farther from the second side 210 (see FIG. 2), causing the interior volume V to be smaller than the interior volume V of the wider configuration in FIG. 1. In other words, the interior volume V is larger when a hook element 125 is in a first elongated opening 130 that is closer to the second side 210, and the interior volume V is smaller when a hook element 125 is in a second elongated opening 130 that is farther from the second side 210 than the first elongated opening 130.

In some embodiments, when the flexible sheet 200 is in the assembled configuration of the cone 100, the intersection of the first side 205 and the second side 210 extends above the top opening 105 and the remainder of the first side 205. In some embodiments, the intersection of the first side 205 and the third side 215 also extends above the top opening 105 and the remainder of the first side 205. These intersections may meet to form a mounting point (e.g., with a mounting hole 112 therethrough) for the cone 100. They also may receive the zip ties 260 in the adjustment openings 255a and either set of corresponding adjustment openings 255b,255c, depending on the selected volume V or interior contour of the cone 100.

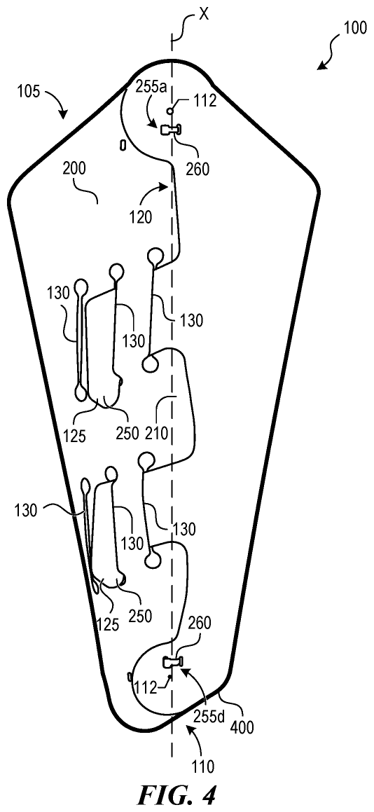

For example, FIG. 4 illustrates a rear perspective view of the variable-volume restraint cone 100 shown in FIG. 1, in yet another assembled configuration in which the seam 120 is bulged to change the interior contour of the cone, according to embodiments of the present technology. In FIG. 4, the adjustment openings 255d are aligned with the adjustment openings 255f, and the adjustment openings 255a are aligned with the adjustment openings 255c, although they may be aligned to other adjustment openings. The zip tie 260 secures the connection between the top and bottom intersections. The hooks 125 may have some tolerance to slide within the elongated openings 130 to change the width of the cone and its volume, such that when a bird is in the cone 100, the seam 120 can bulge outwardly until the second portions 250 of the hooks 125 abut the flexible sheet 200. A visual example of this is seen in the comparison between FIGS. 1 and 4, where the hooks 125 are relatively loose in the elongated openings 130 in FIG. 1, and the seam 120 is tight in FIG. 4. Accordingly, embodiments of the present technology provide a flexible and adjustable seam 120 that can adjust to different-sized birds.

In some embodiments, when the flexible sheet 200 of the cone 100 is in the assembled configuration (e.g., in FIG. 4), the lower opening 110 has an edge 400 that forms a perimeter of the opening, and the perimeter is in a plane that is oriented at an oblique angle relative to a central longitudinal axis X of the cone 100.

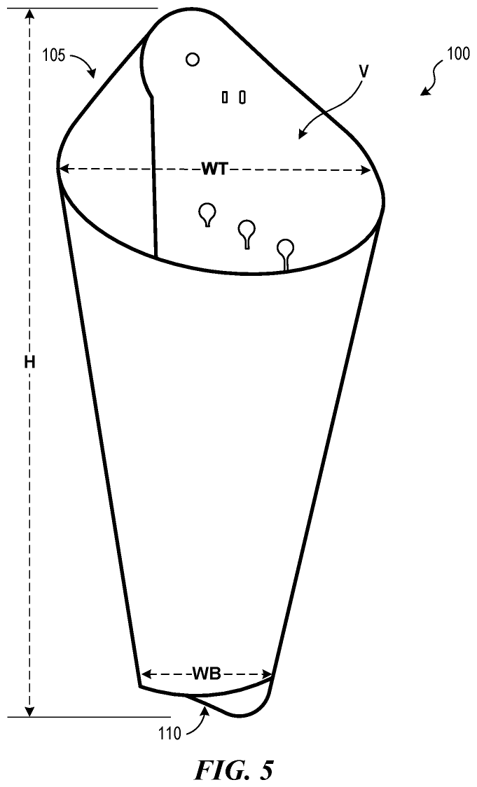

FIG. 5 illustrates a perspective view of the variable-volume restraint cone 100 in an assembled configuration, according to embodiments of the present technology. In some embodiments, as a result of the variable volume adjustment features disclosed herein, the top opening 105 may have a width WT of approximately 10.5 inches, 10 inches, 9.5 inches, or other suitable dimensions, depending on, for example, positioning of the hook elements 125 or positioning of the adjustment openings 255. The bottom opening 110 may have a width WB of approximately 4.25 inches, 3.75 inches, 3.5 inches, or other suitable dimensions, depending on, for example, positioning of the hook elements 125 or the adjustment openings 255. Optionally, but not necessarily, in some embodiments, the cone 100 may be configured such that when it has the larger of the foregoing widths WT, it has the larger of the foregoing widths WB, and likewise for the medium and small widths. In some embodiments, additional groups of hook elements, slots, and adjustment openings may be included to facilitate additional sizes. In some embodiments, the cone 100 may have an overall height H of approximately 25 inches, although the height H may vary depending on the selected configuration of the cone 100. Although specific dimensions are provided herein, such dimensions are not necessary and other embodiments may have other suitable dimensions that are larger or smaller.

In some embodiments, the cone 100 can be made of a suitable flexible or resilient material. In some embodiments, the cone 100 may include high molecular weight polyethylene (HMWPE). HMWPE is advantageous for being sufficiently flexible and strong to facilitate assembly and disassembly of the cone 100 while resisting pull-through of fasteners. HMWPE may also be formed with a smooth surface for facilitating cleaning. In some embodiments, the HMWPE sheet may have a thickness of approximately 1.6 millimeters or 0.6 inches, or other suitable thicknesses. In other embodiments, the cone 100 may include other suitable materials, such as nylon, low density polyethylene (LDPE), polyvinyl chloride (PVC), ultra-high molecular weight polyethylene (UHMW), very-high molecular weight polyethylene (VHMW), or other suitable plastic materials or combinations of materials. In some embodiments, the material can include carbon black to resist degradation from radiation in sunlight.

Embodiments of the present technology provide several advantages over conventional bird-restraint devices. For example, the cones may be adjusted and shaped to adapt to different sizes and shapes of birds. The devices may be shipped or stored flat, which is more efficient than storage or shipment in an assembled conical configuration. Unrolling or disassembling the devices enables easier access to the seam for cleaning. The present technology can also facilitate an assembly process that does not require tools because, for example, the zip ties do not require tools.

From the foregoing, it will be appreciated that specific embodiments of the presently disclosed technology have been described herein for purposes of illustration, but that various modifications may be made without deviating from the scope of the technology.

Certain aspects of the technology described in the context of particular embodiments may be combined or eliminated in other embodiments. Further, while advantages associated with certain embodiments of the presently disclosed technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A restraint device for harvesting birds, the device comprising:
a flexible sheet having a first side, a second side adjoining the first side and extending transversely to the first side, a third side adjoining the first side and extending transversely to the first side, and an arcuate fourth side joining the second side and the third side on an opposite side of the flexible sheet from the first side;
one or more hook elements extending from the third side, wherein at least one of the hook elements comprises a first portion and a second portion extending transversely from the first portion; and
two or more elongated openings extending along, and adjacent to, the second side and positionable to receive the at least one hook element, wherein a first elongated opening of the two or more elongated openings is between a second elongated opening of the two or more elongated openings and the second side; wherein:
the flexible sheet is adaptable between a first configuration in which the flexible sheet is planar, and a second configuration in which the flexible sheet is curled upon itself to form a conical shape;
when the flexible sheet is in the second configuration, the first side forms an upper edge of the conical shape and the fourth side forms a lower edge of the conical shape;
when the flexible sheet is in the second configuration, the device has an interior volume that tapers from the upper edge to the lower edge;
the interior volume is adjustable between a first interior volume when the at least one of the hook elements is in the first elongated opening, and a second interior volume when the at least one of the hook elements is in the second elongated opening, wherein the second interior volume is less than the first interior volume; and
the flexible sheet includes a plurality of additional openings positioned at each intersection of the first, second, third, and fourth sides, wherein the additional openings are configured and positionable to receive one or more fastener devices to selectively increase or decrease the interior volume relative to the first interior volume or the second interior volume.

2. The restraint device of claim 1, wherein the one or more fastener devices includes one or more zip ties.

3. The restraint device of claim 1, wherein the one or more hook elements comprises two hook elements.

4. The restraint device of claim 3, further comprising two or more additional elongated openings extending along, and adjacent to, the second side and positionable to receive at least one of the hook elements, wherein the two or more additional elongated openings are positioned between the two or more elongated openings and the fourth edge.

5. The restraint device of claim 1, wherein the flexible sheet is formed with a plastic material comprising carbon black.

6. The restraint device of claim 1, wherein when the flexible sheet is in the second configuration, the forms a lower edge of the conical shape forms an opening having a perimeter in a plane that is oriented at an oblique angle relative to a central longitudinal axis of the conical shape.

7. The restraint device of claim 1, wherein when the flexible sheet is in the second configuration, each of the intersection of the first side and the second side and the intersection of the first side and the third side extends above a remainder of the upper edge of the conical shape to form a mounting point for attaching the restraint device to a support structure.

8. The restraint device of claim 1, wherein the two or more elongated openings comprises three or more elongated openings, wherein the first and second elongated openings are positioned between a third elongated opening of the three or more elongated openings and the second side.

9. The restraint device of claim 1, wherein at least one of the two or more elongated openings comprises two rounded openings positioned at ends of the at least one elongated opening, wherein the rounded openings are wider than the at least one elongated opening.

10. The restraint device of claim 1, wherein the second portion of the at least one hook element extends parallel to the third side.

11. The restraint device of claim 1, wherein two or more elongated openings extend parallel to the second side.

12. A restraint device for harvesting birds, the device comprising:
a flexible sheet configurable between a first configuration in which the flexible sheet is flat, and a second configuration in which the flexible sheet is formed into a conical shape having an interior volume, an upper opening, and a lower opening smaller than the upper opening;
two or more elongated openings positioned adjacent to a first side of the flexible sheet and extending parallel to the first side; and
two or more hook elements extending from a second side of the flexible sheet;
wherein the hook elements are positionable in the elongated openings to hold the flexible sheet in the second configuration by moving the hook elements into the elongated openings and sliding the hook elements downward to extend below and out of the elongated openings.

13. The restraint device of claim 12, wherein engagement between the two or more hook elements and the two or more elongated openings forms a seam along a length of the restraint device, and wherein the restraint device further comprises one or more fastener devices positionable along the seam to connect the first side and the second side.

14. The restraint device of claim 13, wherein the one or more fastener devices comprises one or more zip ties.

15. The restraint device of claim 13, wherein the interior volume or a contour of an interior surface of the conical shape is variable via positioning the one or more fastening devices.

16. The restraint device of claim 12, wherein the interior volume is a first interior volume, and wherein the flexible sheet is configurable into a third configuration in which the flexible sheet is formed into a conical shape having a second interior volume that is larger or smaller than the first interior volume.

17. A restraint device for harvesting birds, the device comprising:
a flexible sheet configurable between a first configuration in which the flexible sheet is flat, and a second configuration in which the flexible sheet is formed into a conical shape having an interior volume, an upper opening, and a lower opening smaller than the upper opening; and
a means for adjustment of the interior volume;
wherein when the flexible sheet is in the second configuration, the lower opening has a perimeter in a plane that is oriented at an oblique angle relative to a central longitudinal axis of the conical shape.

18. The restraint device of claim 17, wherein the means for adjustment of the interior volume comprises:
a means for coarse adjustment of the interior volume; and
a means for fine adjustment of the interior volume.

19. The restraint device of claim 18, wherein the means for coarse adjustment comprise one or more hook elements and one or more slits, wherein the one or more hook elements are positioned toward an opposite side of the flexible sheet from the one or more slits.

20. The restraint device of claim 19, wherein the means for fine adjustment comprises two or more holes in the flexible sheet and one or more fastener devices positionable to connect two of the two or more holes to each other.

21. The restraint device of claim 20, wherein the one or more fastener devices comprises one or more zip ties.

22. The restraint device of claim 17, wherein the interior volume is a first interior volume, and wherein the flexible sheet is configurable into a third configuration in which the flexible sheet is formed into a conical shape having a second interior volume that is larger or smaller than the first interior volume.
